(19) United States
(12) Patent Application Publication
(10) Pub. No.: US 2014/0219736 A1
(43) Pub. Date: Aug. 7, 2014

(54) Hole Saw and Method

(71) Applicant: Chad Grenner, Woodinville, WA (US)

(72) Inventor: Chad Grenner, Woodinville, WA (US)

(21) Appl. No.: 13/762,161

(22) Filed: Feb. 7, 2013

(51) Int. Cl. B23B 51/04; B23B 51/05

(52) U.S. Cl. CPC B23B 51/0426; B23B 51/05
USPC 408/1 BD; 408/209

(57) ABSTRACT

A breakage resistant hole saw that reduces damage of the pilot hole drill bit caused by the sudden contact of the cutting teeth on the hole saw's cutting body against the hard working surface after the drill bit has penetrated through the working surface. The hole saw disclosed herein includes a cylindrical cutting body mounted on an arbor. Formed on the circular lower edge of the cutting body is a plurality of angled teeth that cut through a working surface when rotated in one direction. Mounted on the end of the arbor is a pilot hole drill bit with a spiral cutting flute configured at a spiral cutting angle to penetrate the working surface when rotated in a direction opposite the cutting direction of the cutting teeth on the cutting body. Also disclosed herein is a method for forming a hole using a hole saw that reduces damage to the pilot hole drill bit.

This utility patent application is based on and claims the filing date benefit of U.S. provisional patent application (Application No. 61/595,800) filed on Feb. 7, 2012.

Notice is hereby given that the following patent document contains original material that is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to hole saws and more particularly, to hole saws designed to resist breakage or bending of the pilot hole drill bit when cutting through a surface.

2. Description of the Related Art

A hole saw is used with a drill to cut circular holes in a work surface. They are commonly used by electricians to cut holes through a hard metallic work surface on an electrical panel.

Hole saws typically include a cylindrical cutting body mounted on an arbor. The upper, proximal end of the arbor is attached to a key or keyless chuck on the end of a hand drill. Formed on the circular lower edge of the cutting body is a plurality of angled cutting teeth made of suitable material to cut through a particular work surface. The teeth on the cutting body are pitched at a particular angled to cut through the work surface only when rotated by the drill in a clockwise direction. When the cutting body is rotated in a counter-clockwise direction, the teeth slide over the work surface and do not cut into it.

Longitudinally aligned and mounted to the distal end of the arbor is a pilot hole drill bit. The drill bit is typically longer than the cutting body so that the tip of the drill bit extends beyond the tips of the cutting teeth formed on the cutting body. In the prior art, the drill bit include a spiral cutting flute configured at a spiral angle to penetrate a work surface when the drill is also rotated in a clockwise direction. When creating holes in a thick work surfaces, the drill bit and the cutting teeth on the cutting body are pressed against the work surface.

During use, the desired location for a hole on a work surface is determined The tip of the pilot hold drill bit is positioned at the center of the hole. The drill is normally held so that the pilot hold drill bit is perpendicular to the work surface. The drill is then activated to rotate the drill bit at a high RPM, (1500 to 2000 RPMs). When drilling, a light inward directed force is exerted on the drill's handle to continuously force the drill bit into the work surface. The amount of force exerted depends on the size of the hole, the hardness of the work surface, and the sharpness of the drill bit. Eventually, the drill bit penetrates the work surface forming the pilot hole.

When cutting holes on a thin, hard work surface, the tip of the drill bit will suddenly penetrate the work surface and any resistance against the inward force exerted by the user on the drill will suddenly dissipate. If the user does not turn off the drill or discontinue exertion of the inward force, the cutting teeth on the cutting body will be pressed into the work surface. If the cutting body is not perpendicularly aligned to the work surface, rotation of the misaligned cutting body on the work surface will bend or break the drill pit. To prevent bending or breakage of the drill bit, the user must immediately release the drill's switch and discontinuation exertion of an inward force against the drill's handle. Unfortunately, knowing the precise moment when the drill bit penetrates the work surface and simultaneously releasing switch and discontinuing inward pressure is difficult. In industries, such as electrical industries, that require workers to repeatedly use hole saws to form circular holes on hard work surfaces, bent or broken drill bits are a major problem and expense.

### SUMMARY OF THE INVENTION

It is an object of the present invention to provide a hole saw that can be used repeatedly and experiences less pilot hole drill bit bending or breakage. The hole saw is designed to address the problem of cutting holes in thin, hard work surfaces in which the cutting teeth on the cutting body of a hole saw may make sudden contact with the work surface and bend or break the drill bit.

The breakage resistant hole saw disclosed herein includes a cylindrical cutting body mounted on distal end of an arbor. Formed on the circular lower edge of the cutting body is a plurality of angled cutting teeth that cut through a thin work surface when rotated in one direction. Mounted on the end of the arbor is a pilot hole drill bit with a spiral cutting flute configured at a spiral angle to penetrate a thin work surface in a direction opposite the cutting direction of the cutting teeth on the cutting body. If the cutting teeth on the cutting body make contact with the work surface when the pilot hole drill bit penetrates the work surface, the cutting teeth on the cutting body will slide over the work surface and not cut into the work surface thereby reducing damage to the drill bit.

Also disclosed herein is a method for forming a hole using a hole saw with a pilot hole drill bit less susceptible to damage caused by the cutting teeth on the hole saw's cutting body making contact with the work surface.

### DESCRIPTION OF THE DRAWINGS

FIG. 1 is a partial sectional, side elevational view of a hole saw disclosed therein attached to the chuck on a reverse directional hand drill showing the pilot hole drill bit being rotated in a counter clockwise direction to from a pilot hole in a work surface.

FIG. 2 is a partial sectional, side elevational view of a hole saw disclosed therein attached to the chuck on a reverse directional hand drill being rotated in a clockwise direction and showing the hole saw being force downward towards the work surface with the pilot hole drill bit disposed in the pilot hole formed by the drill bit in the work surface and showing the cutting teeth on the lower edge of the cylindrical body being positioned against the work surface to cut a large hole.

### DESCRIPTION OF THE PREFERRED EMBODIMENT(S)

A key aspect of the invention disclosed herein is the discovery that the bending or breakage of pilot hole drill bits commonly experienced when using a hole saw on a hard work surface is caused by the sudden cutting action and misalignment of the cutting teeth on the saw's cylindrical body against the work surface when the pilot hole drill bit penetrates the hard surface. By rotating cylindrical body in a non-cutting direction, when the cutting teeth make contact with the hard working surface after the pilot hole drill bit extends through the work surface, bending and breakage of the pilot hole drill bit is reduced.

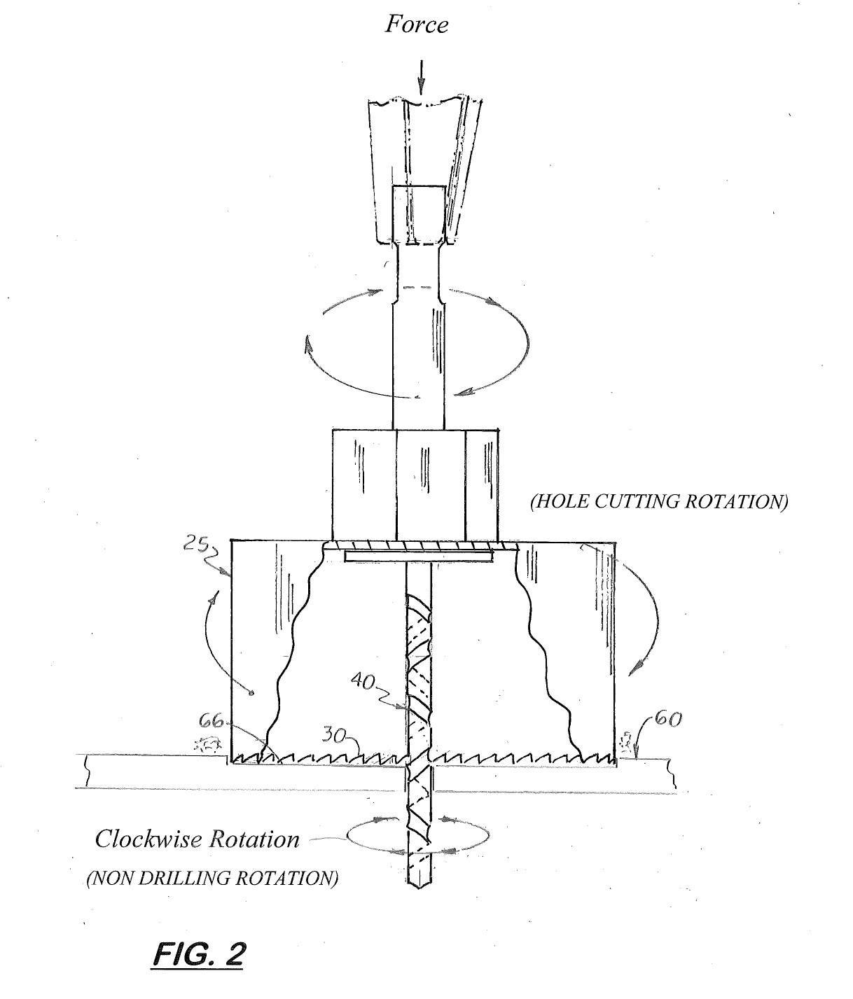

The breakage resistant hole saw 10 includes a cylindrical cutting body 25 mounted on an arbor 12. Formed on the circular lower edge of the cutting body 25 is a plurality of angled teeth 30 that cut through thin working surface 60 when rotated in a clockwise direction as shown in FIG. 2. Mounted on the distal end of the arbor is a pilot hole drill bit 40 with a spiral cutting flute 46 configured at a spiral angle to penetrate a working surface 90 and form a pilot hole 62 when rotated in a counter-clockwise direction.

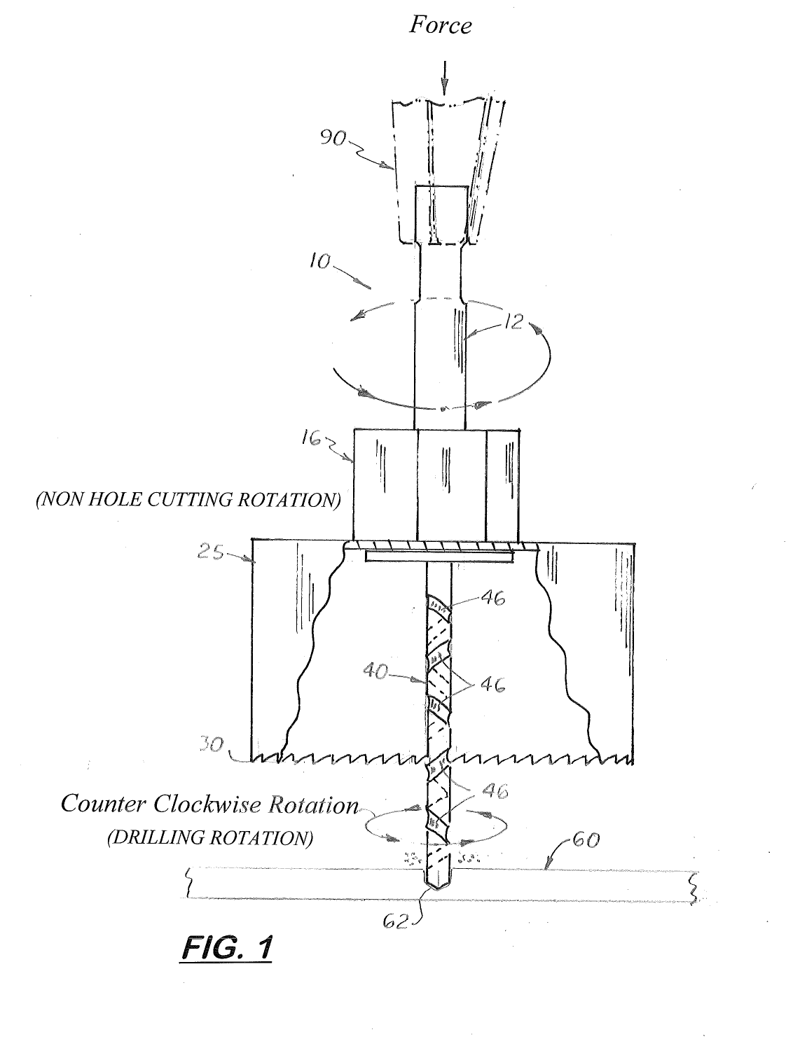

FIG. 1 is a partial sectional, side elevational view of the hole saw 10 attached to the chuck 90 on a reverse directional hand drill. The drill is being rotated in a counter-clockwise direction and being forced downward so that the pilot hole drill bit 40 forms the pilot hole 62 in a work surface 60. When the drill bit 40 penetrates the hard working surface 60, the rotating direction control switch (not shown) is reversed so that the drill will rotate in a clockwise direction.

FIG. 2 is a partial sectional, side elevational view of a hole saw 10 showing the drill, the arbor 90 and hole saw 10 being force downward towards the hard working surface 60 with the pilot hole drill bit 40 being inserted into the pilot hole 62 and the teeth 30 on the lower edge of the cylindrical body 25 being positioned against the working surface 60 to cut a large hole 66.

In the embodiment described above, the drill bit 40 has a spiral cutting flute 46 configured at a spiral angle to penetrate a working surface 90 when rotated in a counter-clockwise direction and with the cutting teeth 30 at a cutting angle to cut through the working surface 90 when rotated in a clockwise direction. It should be understood that the spiral cutting flute 46 configured at a spiral angle to penetrate a working surface 90 when rotated in a clockwise direction and with the cutting teeth 30 at a cutting angle to cut through the working surface 90 when rotated in a counter-clockwise direction.

Also disclosed herein is a method for forming a hole using a hole saw that reduces the number of pilot hole drill bit bending or breakage, comprising the following steps:

a. selecting a breakage resistant hole saw that includes an arbor, a cylindrical cutting body mounted on said arbor, said cutting body includes a circular lower edge of the cutting body with a plurality of angled teeth configured to cut through thin working surface 1 when rotated in one direction, and a pilot hole drill bit mounted on the distal end of said arbor, said pilot hole drill bit includes a spiral cutting flute configured at a spiral angle to penetrate a metal surface when rotated in a direction opposite the cutting direction of said cutting body.

b. attaching said arbor to a chuck on a reversible drill;

c. positioning the tip of the pilot hole drill bit perpendicular to and at desired location on a work surface;

d. rotating the pilot hole drill in direction form a pilot hole in said working surface;

e. discontinuing rotation of said reversible drill;

f. positioning said angle teeth on said cutting body against said working surface while said pilot hole drill bit is extended through said pilot hole; and,

g. activating the and rotating said arbor in a clockwise direction to cut a hole in said work surface.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An improved hole saw, comprising:
a. an arbor;
b. a cylindrical cutting body mounted on said arbor, said cutting body includes a circular lower edge of the cutting body with a plurality of angled teeth configured to cut through thin metal when rotated in one direction; and,
c. a pilot hole drill bit mounted on the distal end of said arbor, said pilot hole drill bit includes a spiral cutting flute configured at a spiral angle to penetrate a metal surface when rotated in a direction opposite the cutting direction of said cutting body.

2. The hole saw, as recited in claim 1 wherein the cutting body and the drill bit are configured to drill into a metallic work surface.

3. A drill mounted hole saw for cutting a desired circular hole in a hard work surface, comprising;
a. a cylindrical cutting body affixed to a drill, said cutting body includes a lower edge with a plurality of cutting teeth configured to cut a hole in the work surface when the drill is rotated in one direction;
b. a pilot hole drill bit affixed to a drill and coaxially aligned to and inside the cutting body, the pilot hole drill bit extends beyond the lower edge of the cutting body and is configured to cut a pilot hole in work surface when the drill is rotated in an direction opposite the direction of the drill when cutting a hole with the cutting body.

4. A method for preventing breakage of drill bit on a hole saw when cutting through a work surface, comprising the following steps;
a. selecting a breakage resistant hole saw that includes an arbor, a cylindrical cutting body mounted on said arbor, said cutting body includes a circular lower edge of the cutting body with a plurality of angled teeth configured to cut through thin working surface when rotated in one direction, and a pilot hole drill bit mounted on the distal end of said arbor, said pilot hole drill bit includes a spiral cutting flute configured at a spiral angle to penetrate a work surface when rotated in a direction opposite the cutting direction of said cutting body.
b. attaching said arbor to a chuck on a reversible drill;
c. positioning the tip of the pilot hole drill bit perpendicular to and at desired location on a work surface;
d. rotating the pilot hole drill in direction form a pilot hole in said working surface;
e. discontinuing rotation of said reversible drill;
f. positioning said angle teeth on said cutting body against said working surface while said pilot hole drill bit is extended through said pilot hole; and,
g. activating the and rotating said arbor in a clockwise direction to cut a hole in said work surface.

5. The hole saw, as recited in claim 1 wherein the work surface is made of metal.
